(19) United States
(12) Patent Application Publication
(10) Pub. No.: US 2010/0271699 A1
(43) Pub. Date: Oct. 28, 2010

(54) COATING COMPOSITION FOR ANTIREFLECTION AND ANTIREFLECTION FILM PREPARED BY USING THE SAME

(75) Inventors: Yeong-Rae Chang, Daejeon Metropolitan City (KR); Hansik Yun, Daejeon Metropolitan City (KR); Hyemin Kim, Daejeon Metropolitan City (KR); Boo Kyung Kim, Daejeon Metropolitan City (KR)

Correspondence Address: MCKENNA LONG & ALDRIDGE LLP, 1900 K STREET, NW, WASHINGTON, DC, 20006, US

(73) Assignee: LG CHEM, LTD., Seoul (KR)

(21) Appl. No.: 12/742,615

(22) PCT Filed: Nov. 13, 2008
(86) PCT No.: PCT/KR2008/006702

§ 371 Date: May 12, 2010

(30) Foreign Application Priority Data
Nov. 13, 2007 (KR) 10-2007-0115343

(51) Int. Cl. G02B 5/30; B05D 5/06; B32B 7/02; C08L 83/00; C08L 33/00; C08J 3/28; C08K 3/22; C08K 3/10

(52) U.S. Cl. 359/485; 427/162; 428/212; 524/858; 524/878; 522/153; 524/783; 524/780; 524/784; 524/786

(57) ABSTRACT

The present invention provides a coating composition for antireflection that includes a) a low refractive material having a refractive index of 1.2 to 1.45, b) a high refractive material having a refractive index of 1.55 to 2.2 and comprising high refractive fine particles and an organic substituent, in which the difference in the surface energy between two materials is 5 mN/m or more; an antireflection film manufactured using the coating composition for antireflection; and a method of manufacturing the antireflection film. According to the present invention, the antireflection film having excellent antireflection characteristic can be manufactured by one coating process, thereby reducing manufacturing cost.

### TECHNICAL FIELD

The present invention relates to a coating composition for antireflection, an antireflection film manufactured using the coating composition for antireflection, and a method of manufacturing the antireflection film. More particularly, the present invention relates to a coating composition for antireflection, in which phase separation of ingredients occurs on a single coating layer that is formed by one coating process, and thus a multi-layer structure is formed to provide an optical film with antireflection characteristic; an antireflection film manufactured using the coating composition for antireflection; and a method of manufacturing the antireflection film.

This application claims priority from Korean Patent Application No. 10-2007-0115343 filed on Nov. 13, 2007 in the Korean Intellectual Property Office, the disclosure of which is incorporated herein by reference in its entirety.

### BACKGROUND ART

An object to perform a surface treatment on the surface of a display is to improve image contrast by improving the abrasion resistance of the display and decreasing the reflection of light emitted from an external light source. The decrease of the reflection of external light can be achieved by two methods. One method causes diffused reflection by using convexo-concave shape on the surface, and the other method causes destructive interference by using a multi-coating design.

Anti-glare coating using the convexo-concave shape on the surface has been generally used in the related art. However, there have been problems in that resolution deteriorates in a high-resolution display and the sharpness of an image deteriorates due to diffused reflection. In order to solve the above-mentioned problems, Japanese Patent Application Publication No. 11-138712 has disclosed a light-diffusion film where light is diffused in a film that is manufactured by using organic filler having a refractive index different from a binder. However, since there are problems in that luminance and contrast deteriorate, the light-diffusion film needs to be modified.

A method of causing the destructive interference of reflected light by a multi-coating design has been disclosed in Japanese Patent Application Publication Nos. 02-234101 and 06-18704. According to this method, it is possible to obtain antireflection characteristic without the distortion of an image. In this case, light reflected from layers should have phase difference in order to allow reflected light to destructively interfere, and a waveform of reflected light should have amplitude so that reflectance can be minimized reflectance during the destructive interference. For example, when an incidence angle with respect to a single antireflection coating layer provided on the substrate is 0°, the following expressions can be obtained.

[Math Equation 1]

nₒnₛ=n₁²

2n₁d₁=(m+½)λ (m=0, 1, 2, 3 . . . )

(nₒ: the refractive index of air, nₛ: the refractive index of a substrate, nᵢ: the refractive index of a film, dₗ: the thickness of the film, λ: the wavelength of incident light)

In general, if the refractive index of the antireflection coating layer is smaller than the refractive index of the substrate, antireflection is effective. However, in consideration of the abrasion resistance of the coating layer, it is preferable that the refractive index of the antireflection coating layer is 1.3 to 1.5 times of the refractive index of the substrate. In this case, the reflectance is smaller than 3%. However, when an antireflection coating layer is formed on a plastic film, it is not possible to satisfy the abrasion resistance of a display. For this reason, a hard coating layer of several microns needs to be provided below the antireflection coating layer. That is, the antireflection coating layer using the destructive interference includes a hard coating layer for reinforcing abrasion resistance, and one to four antireflection coating layers that are formed on the hard coating layer. Accordingly, the multi-coating method obtains antireflection characteristic without the distortion of an image. However, there is still a problem in that manufacturing cost is increased due to the multi-coating.

A method of allowing reflected light to destructively interfere by a single coating design has been proposed in recent years. The following method has been disclosed in Japanese Patent Application Publication No. 07-168006. According to the method, ultrafine particle-dispersed liquid is applied on a substrate, and the spherical shapes of fine particles are exposed to the surface so that the difference in refractive index is gradually generated between air (interface) and the particle. As a result, it is possible to obtain antireflection characteristic. However, since the shape and size of the ultrafine particles should be uniform and these particles should be uniformly distributed on the substrate, it is difficult to achieve this method by general coating processes. Further, since the amount of a binder should be equal to or smaller than a predetermined amount in order to obtain a spherical shape on the surface of the film, there is a problem in that this method is very vulnerable to abrasion resistance. Further, since the coating thickness should be also smaller than the diameter of the fine particle, it is very difficult to obtain abrasion resistance.

### DISCLOSURE

### Technical Problem

It is an object of the prevent invention to provide a coating composition for antireflection, in which although the coating composition is used to form a single coating layer by one coating process, ingredients have a concentration gradient in a thickness direction of the single coating layer functionally to form two or more layers, thereby providing excellent antireflection characteristic; an antireflection film manufactured using the coating composition for antireflection; and a method of manufacturing the antireflection film.

### Technical Solution

In order to achieve the above-mentioned object, the present invention provides a coating composition for antireflection that includes

a) a low refractive material having a refractive index of 1.2 to 1.45,
b) a high refractive material having a refractive index of 1.55 to 2.2 and comprising high refractive fine particles and an organic substituent, in which the difference in the surface energy between two materials is 5 mN/m or more.

Further, the present invention provides an antireflection film comprising a single coating layer that includes a) a low refractive material having a refractive index of 1.2 to 1.45, b) a high refractive material having a refractive index of 1.55 to 2.2 and comprising high refractive fine particles and an organic substituent, in which the difference in the surface energy between two materials is 5 mN/m or more and the low and high refractive materials have a concentration gradient in a thickness direction.

Further, the present invention provides an antireflection film comprising a single coating layer that includes a) a low refractive material having a refractive index of 1.2 to 1.45, and b) a high refractive material having a refractive index of 1.55 to 2.2, in which the difference in the surface energy between two materials is 5 mN/m or more, the low and high refractive materials have a concentration gradient in a thickness direction, and the single coating layer has a thickness of 1 micrometer or less.

Further, the present invention provides a method of manufacturing an antireflection film, comprising the steps of

i) preparing a coat ing composition for antireflection that includes

a) a low refractive material having a refractive index of 1.2 to 1.45,
b) a high refractive material having a refractive index of 1.55 to 2.2 and comprising high refractive fine particles and an organic substituent, in which the difference in the surface energy between two materials is 5 mN/m or more;

ii) applying the coating composition on a substrate to form a coating layer;

iii) drying the coating layer to allow the low and high refractive materials to have a concentration gradient in a thickness direction of the coating layer; and

iv) curing the dried coating layer.

Further, the present invention provides a polarizing plate, comprising i) a polarizing film and ii) the antireflection film including a single coating layer that includes a) a low refractive material having a refractive index of 1.2 to 1.45, b) a high refractive material having a refractive index of 1.55 to 2.2 and comprising high refractive fine particles and an organic substituent, in which the difference in the surface energy between two materials is 5 mN/m or more and the low and high refractive materials have a concentration gradient in a thickness direction.

Further, the present invention provides a polarizing plate, comprising i) a polarizing film and ii) the antireflection film including a single coating layer that includes a) a low refractive material having a refractive index of 1.2 to 1.45 and b) a high refractive material having a refractive index of 1.55 to 2.2, in which the difference in the surface energy between two materials is 5 mN/m or more, the low and high refractive materials have a concentration gradient in a thickness direction, and the single coating layer has a thickness of 1 micrometer or less.

Furthermore, the present invention provides a display device, comprising the antireflection film or the polarizing plate.

### ADVANTAGEOUS EFFECTS

The antireflection film according to the present invention has excellent optical characteristics, and can be manufactured by one coating process. Therefore, it is possible to reduce manufacturing cost.

### BEST MODE

Hereinafter, the present invention will be described in detail as follows.

The coating composition for antireflection according to the present invention is characterized in that it includes a) a low refractive material having a refractive index of 1.2 to 1.45, b) a high refractive material having a refractive index of 1.55 to 2.2 and comprising high refractive fine particles and an organic substituent, in which the difference in the surface energy between two materials is 5 mN/m or more.

In the present invention, although the above-mentioned coating composition is used to form a single coating layer by one coating process, phase separation of the ingredients occurs in the single coating layer due to the difference in the surface energy functionally to form a multi-layer structure. That is, there are a region having a high concentration of the high refractive material and a region having a high concentration of the low refractive material in the single coating layer.

Specifically, the low refractive material moves toward the hydrophobic air side of the coating layer, and the high refractive material moves toward and is distributed in the substrate side of the coating layer. Accordingly, the single coating layer exhibits antireflection characteristic.

In the present invention, the low refractive material may be a thermosetting or UV curable resin having a refractive index of 1.2 to 1.45. In particular, it is preferable to use low refractive-fluorinated materials having both low surface energy and low refractive index, in order to induce phase separation due to the difference in the surface energy.

In addition, it is preferable that the low refractive material has a surface energy of 25 mN/m or less, in order to more effectively induce the phase separation. It is preferable that the low refractive material has a surface energy of more than 0 mN/m.

It is preferable that the low refractive-thermosetting material includes one or more selected from the group consisting of an alkoxysilane reactant that may cause a sol-gel reaction, a urethane reactive group compound, a urea reactive group compound, and an esterification reactant.

It is preferable that the low refractive-thermosetting material includes fluorine, in order to achieve low refractive characteristic and reduce surface energy.

The alkoxysilane reactant is a reactive oligomer that is manufactured by performing hydrolysis and a condensation reaction of alkoxysilane, fluorinated alkoxysilane, silane-based organic substituents under the conditions of water and a catalyst through a sol-gel reaction. In this case, when being measured by GPC while polystyrene is used as a reference material, the average molecular weight of the reactive oligomer is preferably in the range of 1,000 to 200,000. A condensation reaction is performed at a temperature equal to or higher than room temperature after coating, so that the alkoxysilane reactant manufactured as described above forms a net having the cross-linking structure.

The alkoxysilane can give strength to a level required in an outermost thin film. The alkoxysilane may adopt tetraalkoxysilanes or trialkoxysilanes. The alkoxysilane is preferably at least one selected from the group consisting of tetramethoxy silane, tetraethoxy silane, tetraisopropoxysilane, methyltrimethoxysilane, methyltriethoxysilane, glycycloxy propyl trimethoxysilane, and glycycloxy propyl triethoxysilane, but is not limited thereto.

The fluorinated alkoxysilane lowers the refractive index and surface tension of the coating film to facilitate a distribution difference with the high refractive material. The fluorinated alkoxysilane is preferably one or more selected from the group consisting of tridecafluorooctyltriethoxysilane, heptadecafluorodecyltrimethoxysilane, and heptadecafluorodecyltriisopropoxysilane, but is not limited thereto.

As the silane-based organic substituent, any compound may be used without limitation, as long as it can chemically bind with alkoxysilane, and is compatible and reactive to the high refractive material. The silane-based organic substituent is preferably one or more selected from the group consisting of vinyl trimethoxy silane, vinyl tri(beta-methoxyethoxy)silane, vinyl triethoxy silane, vinyl tri-n-propoxy silane, vinyl tri-n-pentoxy silane, vinylmethyl dimethoxy silane, diphenyl ethoxyvinylsilane, vinyl triisopropoxy silane, divinyl di(beta-methoxyethoxy)silane, divinyl dimethoxy silane, divinyl diethoxy silane, divinyl di-n-propoxy silane, divinyl di(isopropoxy)silane, divinyl di-n-pentoxy silane, 3-acryloxypropyl trimethoxy silane, 3-methacryloxypropyl trimethoxy silane, gamma-methacryloxypropyl methyl diethoxy silane, gamma-methacryloxypropyl methyl diethoxysilane, but is not limited thereto.

The basic monomer alkoxysilane is preferably contained in an amount of 5 to 50 parts by weight, based on the 100 parts by weight of the alkoxysilane reactant. If the content is less than 5 parts by weight, it is difficult to obtain excellent abrasion resistance. If the content is more than 50 parts by weight, it is difficult to achieve low refractive characteristic of the alkoxysilane reactant and phase separation from the high refractive resin.

In order to have a refractive index of 1.2 to 1.45 and facilitate a distribution difference with the high refractive material, the fluorinated alkoxysilane is preferably used in an amount of 20 to 90 parts by weight, based on 100 parts by weight of the alkoxysilane reactant. If the content is less than 20 parts by weight, it is difficult to achieve low refractive characteristic. If the content is more than 90 parts by weight, it is difficult to achieve the stability of liquid and scratch resistance.

In order to maintain compatibility and stability of the alkoxysilane reactant in the coating solution, the content of the silane-based organic substituent is preferably 0 to 50 parts by weight, based on 100 parts by weight of the alkoxysilane reactant. If the content is more than 50 parts by weight, it is difficult to achieve low refractive characteristic and induce a distribution difference with the high refractive material.

The alkoxysilane reactant is preferably prepared through a sol-gel reaction. The sol-gel reaction may adopt any method commonly used in the art. The sol-gel reaction is conducted at a reaction temperature of 20 to 150° C. for 1 to 100 hours, including alkoxysilane, fluorinated alkoxysilane, a silane-based organic substituent, a catalyst, water and an organic solvent.

The catalyst to be used in the sol-gel reaction is an ingredient that is required for controlling the sol-gel reaction time. The catalyst is preferably an acid such as nitric acid, hydrochloric acid, sulfuric acid, and acetic acid, and more preferably hydrochloride, nitrate, sulfate, or acetate of zirconium or indium. In this connection, the catalyst is preferably used in the amount of 0.1 to 10 parts by weight, based on 100 parts by weight of the alkoxysilane reactant.

The water to be used in the sol-gel reaction is required for hydrolysis and condensation, and is used in the amount of 5 to 50 parts by weight, based on 100 parts by weight of the alkoxysilane reactant.

The organic solvent to be used in the sol-gel reaction is an ingredient to control a molecular weight of hydrolysis condensate. The organic solvent is preferably a single solvent or a mixed solvent selected from the group consisting of alcohols, cellosolves and ketones. In this connection, the organic solvent is preferably contained in an amount of 0.1 to 50 parts by weight, based on 100 parts by weight of the alkoxysilane reactant.

Meanwhile, the urethane reactive group compound may be manufactured by the reaction between alcohol and an isocyanate compound while a metal catalyst is used. If a solution including a metal catalyst, multifunctional isocyanate, and multifunctional alcohol having two or more functional groups is applied to a substrate and maintained at a temperature equal to or higher than room temperature, it is possible to form the net structure including a urethane reactive group. In this case, a fluorine group may be introduced in the alcohol or the isocyanate, in order to achieve low refractive characteristic and induce the distribution difference with the high refractive material.

Examples of the multifunctional alcohol containing fluorine may include 1H,1H,4H,4H-perfluoro-1,4-butanediol, 1H,1H,5H,5H-perfluoro-1,5-pentanediol, 1H,1H,6H,6H-perfluoro-1,6-hexanediol, 1H,1H,8H,8H-perfluoro-1,8-octanediol, 1H,1H,9H,9H-perfluoro-1,9-nonanediol, 1H,1H,10H,10H-perfluoro-1,10-decanediol, 1H,1H,12H,12H-perfluoro-1,12-dodecanediol, fluorinated triethylene glycol, and fluorinated tetraethylene glycol, but are not limited thereto.

Aliphatic isocyanate, cycloaliphatic isocyanate, aromatic isocyanate, or heterocyclic isocyanate may be preferably used as an isocyanate ingredient that is used to manufacture the urethane reactive group compound. Specifically, diisocyanate, such as hexamethylene diisocyanate, 1,3,3-trimethylhexamethylene diisocyanate, isophorone diisocyanate, toluene-2,6-diisocyanate, and 4,4′-dicyclohexane diisocyanate, or three or more functional isocyanate, for example, DN950 and DN980 (trade name) manufactured by DIC corporation may be preferably used as the isocyanate ingredient.

In the present invention, a catalyst may be used to manufacture the urethane reactive group compound. A Lewis acid or a Lewis base may be used as the catalyst. Specific examples of the catalyst may include tin octylate, dibutyltin diacetate, dibutyltin dilaurate, dibutyltin mercaptide, dibutyltin dimaleate, dimethyltin hydroxide, and triethylamine, but are not limited thereto.

The content of the isocyanate and the multifunctional alcohol, which are used to manufacture the urethane reactive group compound, is preferably set so that the molar ratio (NCO/OH) of the functional groups, a NCO group and an OH group is preferably in the range of 0.5 to 2, and more preferably in the range of 0.75 to 1.1. If the mole ratio of the functional groups is less than 0.5 or exceeds 2, the unreacted functional groups are increased. As a result, there may be a problem in that the strength of the film deteriorates.

The urea reactive group compound may be manufactured by the react ion between amine and isocyanates. The manufacture of the urea reactive group compound may employ isocyanates, which is the same as the isocyanates used to manufacture the urethane reactive group compound. Two or more functional perfluoro amines may be used as the amines. If necessary, a catalyst may be used in the present invention. A Lewis acid or a Lewis base may be used as the catalyst. Specific examples of the catalyst may include tin octylate, dibutyltin diacetate, dibutyltin dilaurate, dibutyltin mercaptide, dibutyltin dimaleate, dimethyltin hydroxide, and triethylamine, but are not limited thereto.

The esterification reactant may be obtained by the dehydration and condensation react ion between an acid and alcohol. If the esterification reactant is also mixed in the coating composition, it is possible to form a film having the cross-linking structure. It is preferable that two or more functional acids including fluorine are used as the acid. Specific examples thereof may include perfluorosucinic acid, perfluoroglutaric acid, perfluoroadipic acid, perfluorosuberic acid, perfluoroazelaic acid, perfluorosebacic acid, and perfluorolauric acid. The multifunctional alcohol is preferably used as the alcohol. Examples of the multifunctional alcohol include 1,4-butanediol, 1,2-butanediol, 1,5-pentanediol, 2,4-pentanediol, 1,4-cyclohexanediol, 1,6-hexanediol, 2,5-hexanediol, 2,4-heptanediol, pentaerythritol, and trimethylolpropane, but are not limited thereto. An acid catalyst such as a sulphuric acid or alkoxytitan such as tetrabutoxytitan may be used in the esterification reaction. However, the material used in the esterification reaction is not limited to the above-mentioned material.

The low refractive UV curable material may include an acrylate resin, a photoinitiator and a solvent.

Examples of the acrylate resin may include acrylate monomer, urethane acrylate oligomer, epoxy acrylate oligomer, and ester acrylate oligomer. Specific examples thereof may include dipentaerythritol hexaacrylate, pentaerythritol tri/tetra acrylate, trimethylene propane triacrylate, ethylene glycol diacrylate, but are not limited thereto. As the acrylate resin, fluorinated acrylate may be used, and the fluorinated acrylate may be one or more selected from the group consisting of compounds further having a C₁-C₆ hydrocarbon group as a substituent, which are represented by the following Formulae 1 to 5.

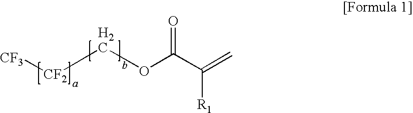

wherein R₁ is —H or C₁-C₆ hydrocarbon, a is an integer of 0 to 4, and b is an integer of 1 to 3. The C₁-C₆ hydrocarbon group is preferably a methyl group (—CH₃).

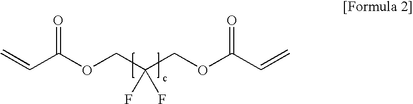

wherein c is an integer of 1 to 10.

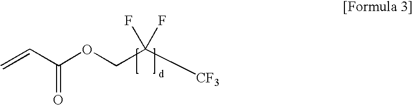

wherein d is an integer of 1 to 9.

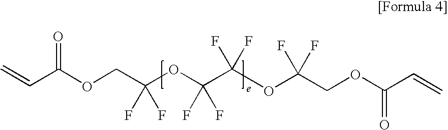

wherein e is an integer of 1 to 5.

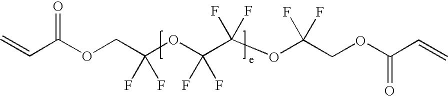

wherein f is an integer of 4 to 10.

The fluorinated acrylate is preferably used in an amount of 20 parts by weight or more, based on 100 parts by weight of the acrylate resin.

The photoinitiator is preferably a compound degradable by UV, and examples thereof may include 1-hydroxy cyclohexyl phenyl ketone, benzyl dimethyl ketal, hydroxy dimethyl acetophenone, benzoin, benzoin methyl ether, benzoin ethyl ether, benzoin isopropyl ether, and benzoin butyl ether, but are not limited thereto.

The photoinitiator is preferably used in an amount of 1 to 20 parts

by weight, based on 100 parts by weight of the acrylate resin. If the content is less than 1 part by weight, proper curing may not occur. If the content is more than 20 parts by weight, scratch resistance and abrasion resistance of the coating film may deteriorate.

In consideration of a coating property, the organic solvent may used, preferably alcohols, acetates, ketones, aromatic solvents or the like. Specifically, examples of the organic solvent may include methanol, ethanol, isopropyl alcohol, butanol, 2-methoxy ethanol, 2-ethoxy ethanol, 2-butoxy ethanol, 2-isopropoxy ethanol, methyl acetate, ethyl acetate, butyl acetate, methyl ethyl ketone, methyl isobutyl ketone, cyclohexane, cyclohexanone, toluene, xylene, and benzene.

The solvent is preferably used in an amount of 10 to 90 parts by weight, based on 100 parts by weight of the low refractive-UV curable material. If the content is less than 10 parts by weight, it is difficult to achieve phase separation from the low refractive material due to high viscosity of the coating solution, and there is a problem in that flatness of the coating film may deteriorate. If the content is more than 90 parts by weight, there are problems in that scratch resistance and abrasion resistance of the coating film may deteriorate, and viscosity of the coating solution may be significantly reduced not to transfer to a coating

machine and substrate.

The low refractive UV curable material may further include a surfactant. Example of the surfactant may include a levelling agent or a wetting agent, in particular, fluorine compounds or polysiloxane compounds.

The surfactant is preferably used in an amount of 5 parts by weight, based on 100 parts by weight of the low refractive-UV curable material. If the content is more than 5 parts by weight, it is difficult to achieve phase separation from the high refractive material, and there are problems in that adherence to the substrate, scratch resistance and abrasion resistance of the coating film may deteriorate.

The high refractive material having a refractive index of 1.55 to 2.2 has a surface energy, which is 5 mN/m more than that of the low refractive material, and includes high refractive fine particles and an organic substituent, and may include an organic solvent for coatability.

The high refractive fine particles increase the refractive index of the high refractive material, and may provide an antistatic effect. It is preferable that the high refractive fine particle has a refractive index of 1.55 to 2.2. Metal oxide may be used as a material for the high refractive fine particle, and the metal oxide may have conductivity. Specifically, examples thereof may include one or more selected from the group consisting of zirconium oxide (ZrO₂), titanium oxide (TiO₂), zinc sulfide (ZnS), antimony oxide (Sb₂O₃), zinc oxide (ZnO₂), indium tin Oxide (ITO), antimony tin oxide (ATO), titanium-antimony tin oxide (TiO₂, Sb doped SnO₂), cerium oxide (Ce0), selenium oxide (SeO₂), aluminum oxide (Al₂O₃), yttrium oxide (Y₂O₃), antimony-zinc oxide (AZO). The high refractive fine particle has a diameter of 1,000 nm or less, preferably 1 to 200 nm, more preferably 2 to 100 nm, and most preferably 10 to 50 nm.

An organic substituent may be used, so that binding of the high refractive fine particles is induced in the coating layer to provide abrasion resistance. In the case where the low refractive material is a thermosetting material, a silane substituent is preferably used as the organic substituent. In the case where the low refractive material is a UV curable material, an acrylate substituent is preferably used as the organic substituent.

Suitable examples of the thermosetting organic substituent may include silane reactant, urethane reactant containing isocyanate and alcohol, urea reactant containing isocyanate and amine, and ester reactant containing acid and alcohol. Preferred examples of the UV curable organic substituent may include two or more functional acrylate monomer or oligomer. However, the reactants are preferably typical reactants containing no fluorine.

The organic substituent is preferably used in an amount of 70 parts by weight or less, based on 100 parts by weight of the high refractive fine particle. If the content is more than 70 parts by weight, it is difficult to achieve high refraction of the material, and the antistatic effect of antistatic fine particles may deteriorate.

Reflectance is determined depending on the content ratio and coating thickness of the low and high refractive materials. A preferred weight ratio of low refractive material/high refractive material is 3/7 to 8/2. The coating thickness is preferably 1 micrometer or less, and more preferably 50 to 500 nm. If the coating thickness is more than 1 micrometer, it is difficult to achieve a desirable reflectance.

It is preferable that the low refractive material and the high refractive material have the same curing type. That is, all of the materials are preferably UV curable or thermosetting materials.

After completing the drying and curing process, the difference in the refractive indices of the cured products of the above mentioned low and high refractive materials is preferably 0.01 or more. In this case, the single coating layer functionally forms a GRIN (gradient refractive index) structure consisting of two or more layers, so as to obtain an antireflection effect. In this connection, when the cured low refractive material has the surface energy of 25 mN/m or less, and the difference in the surface energy between low and high refractive materials is 5 mN/m or more, phase separation occurs effectively.

The present invention provides an antireflection film manufactured by using the above-mentioned coating composition for antireflection, and a method of manufacturing the same.

The method of manufacturing an antireflection film according to the present invention comprises the steps of:

i) preparing a coating composition for antireflection that includes

a) a low refractive material having a refractive index of 1.2 to 1.45,
b) a high refractive material having a refractive index of 1.55 to 2.2 and comprising high refractive fine particles and an organic substituent, in which the difference in the surface energy between two materials is 5 mN/m or more;

ii) applying the coating composition on a substrate to form a coating layer;

iii) drying the coating layer to allow the low and high refractive materials to have a concentration gradient in a thickness direction of the coating layer; and

iv) curing the dried coating layer.

In step ii), the substrate may be abrasion resistance-treated hard coating film, or glass, plastic sheet and film. Examples of the plastic film may include a triacetate cellulose film, a norbornene cycloolefin polymer, a polyester film, a poly methacrylate film, and a polycarbonate film. In the case of the hard coating film, it is suitable that the hard coating film has a refractive index of 1.45 to 1.65 and basic optical properties, adherence, scratch resistance and recoatability. In general, the hard coating layer that is disposed between the substrate and the single coating layer has an acrylate coating layer crosslinked by UV radiation, if necessary, nanoparticles to prevent abrasion resistance and contraction.

In step ii), the method of applying the coating composition may adopt various methods such as bar coating, two-roll or three-roll reverse coating, gravure coating, die coating, micro gravure coating, and comma coating, which may be selected depending on types of the substrate and rheological properties of the coating solution without any restriction. The dried coating thickness is preferably in the range of 50 to 500 nm, more preferably in the range of 100 to 300 nm.

In step iii), the drying process may be performed at a temperature of 5 to 150° C. for 0.1 to 60 min in order to generate phase separation in the coating layer and to remove the organic solvent. If the temperature is less than 5° C., the organic solvent is not completely removed to deteriorate the degree of cure upon UV curing. If the temperature is more than 150° C., the curing may occur before the ingredients is distributed in the coating layer to have a concentration gradient.

In step iv), the curing process may be performed by UV or heat depending on types of the used resin. The heat curing may be performed at a temperature of 20 to 150° C. for 1 to 100 min. If the temperature is less than 20° C., the curing rate is too low to reduce the curing time. If the temperature is more than 150° C., there is a problem in stability of the coating substrate. The UV curing process may be performed at UV radiation dose of 0.1 to 2 J/cm² for 1 to 600 sec. If the UV radiation dose is not within the above range, an uncured resin remains on the coating layer, and thus the surface becomes sticky not to ensure abrasion resistance. If the UV radiation dose exceeds the above range, the degree of the UV curable resin may be too increased.

The antireflection film according to the present invention, manufactured by using the above-mentioned coating composition for antireflection and the method of manufacturing an antireflection film, comprises a single coating layer that includes a) a low refractive material having a refractive index of 1.2 to 1.45, b) a high refractive material having a refractive index of 1.55 to 2.2 and comprising high refractive fine particles and an organic substituent, in which the difference in the surface energy between two materials is 5 mN/m or more and the low and high refractive materials have a concentration gradient in a thickness direction. The antireflection film may further include a substrate provided on one side, and further include a hard coating layer between the substrate and the single coating layer.

In the antireflection film, the low refractive material, which is included in a region corresponding to 50% in a thickness direction from the surface of the antireflection layer facing air, is preferably 70% or more, more preferably 85% or more, and most preferably 95% or more, based on the total weight of the low refractive material.

The antireflection film according to the present invention has a reflectance of less than 3% to exhibit the excellent antireflection effect. Further, the antireflection film according to the present invention has transmittance of 96% or more, minimum reflectance of 0.5% or less, and abrasion resistance of pencil hardness, 2H. Furthermore, the antireflection film according to the present invention may have an antistatic property by the high refractive fine particles.

In the present invention, by using the above-mentioned coating composition and the method of manufacturing the antireflection film, an antireflection layer consisting of the single coating layer may be formed in a thickness of 1 micrometer or less, and more preferably in a thickness of 50 to 500 nm. Accordingly, the present invention provides an antireflection film comprising a single coating layer that includes a) a low refractive material having a refractive index of 1.2 to 1.45, and b) a high refractive material having a refractive index of 1.55 to 2.2, in which the difference in the surface energy between two materials is 5 mN/m or more, the low and high refractive materials have a concentration gradient in a thickness direction, and the single coating layer has a thickness of 1 micrometer or less.

Further, the present invention provides a polarizing plate comprising the above-mentioned antireflection film according to the prevent invention.

Specifically, the polarizing plate according to one embodiment of the present invention comprises i) a polarizing film and ii) the antireflection film including a single coating layer that includes a) a low refractive material having a refractive index of 1.2 to 1.45, b) a high refractive material having a refractive index of 1.55 to 2.2 and comprising high refractive fine particles and an organic substituent, in which the difference in the surface energy between two materials is 5 mN/m or more and the low and high refractive materials have a concentration gradient in a thickness direction.

The polarizing plate according to another embodiment of the present invention comprises i) a polarizing film and ii) the antireflection film including a single coating layer that includes a) a low refractive material having a refractive index of 1.2 to 1.45 and b) a high refractive material having a refractive index of 1.55 to 2.2, in which the difference in the surface energy between two materials is 5 mN/m or more, the low and high refractive materials have a concentration gradient in a thickness direction, and the single coating layer has a thickness of 1 micrometer or less.

A protection film may be provided between the polarizing film and the antireflection film. In addition, the substrate, which is used to form the single coating layer during the manufacture of the antireflection film, may be used as the protection film, as it is. The polarizing film and the antireflection film may be combined with each other by an adhesive. The polarizing film known in the art may be used. A hard coating layer may be provided on one side of the single coating layer, preferably between the polarizing plate and the single coating layer.

The present invention provides a display that includes the antireflection film or the polarizing plate. The display device may be a liquid crystal display or a plasma display. The display device according to the present invention may have the structure known in the art, except for the fact that the antireflection film according to the present invention is provided. For example, in the display device according to the present invention, the antireflection film may be provided on the outermost surface of a display panel facing an observer or on the outermost surface thereof facing a backlight. Further, the display device according to the present invention may include a display panel, a polarizing film that is provided on at least one side of the panel, and an antireflection film that is provided on the side opposite to the side of the polarizing film facing the panel.

### MODE FOR INVENTION

Hereinafter, the preferred Examples are provided for better understanding. However, these Examples are for illustrative purposes

only, and the invention is not intended to be limited by these Examples.

### Preparation Example 1

### Low Refractive Material

20 g of tetraethoxysilane, 20 g of heptadecafluorodecyltrimethoxysilane, 10 g of methacryloxypropyltrimethoxysilane, 2 g of nitric acid, 10 g of water, and 138 g of ethanol were mixed together, and reacted at 50° C. for 10 hrs, followed by dilution with 498.8 g of ethanol.

At this time, it was found that the resulting composition had the solid content of 5% by weight, a refractive index of 1.36, and a surface energy of 14.0 mN/m. After the prepared composition was applied to a triacetate cellulose film having a thickness of 80 μm using a wire bar (No. 5), dried, and cured, the refractive index and surface energy of the cured product were measured. The refractive index was measured using an Ellipsometer, and the surface energy was measured using prop shape analysis system, DSA100 (KRUSS), and water and diiodomethane (CH₂I₂) as a standard.

### Preparation Example 2

### Low Refractive Material

1 part by weight of dipentaerythritol hexaacrylate (DPHA) as multifunctional acrylate, 3 parts by weight of 1H,1H,6H,6H-perfluoro-1,6-hexylacrylate as fluorinated acrylate to provide low refractive index, 1 part by weight of Irgacure 907 as a photoinitiator, 20 parts by weight of diacetone alcohol (DAA) and 75 parts by weight of methylethylketone (MEK) as a solvent were uniformly mixed to prepare a low refractive-UV curable solution.

At this time, it was found that the resulting composition had the solid content of 5% by weight, a refractive index of 1.43, and a surface energy of 23.0 mN/m.

### Preparation Example 3

### Low Refractive Material

30 g of tetraethoxysilane, 20 g of methacryloxypropyltrimethoxysilane, 2 g of nitric acid, 10 g of water, and 62 g of ethanol were mixed together, and reacted at 50° C. for 5 hrs, followed by dilution with 464.8 g of ethanol.

At this time, it was found that the resulting composition had the solid content of 5% by weight, a refractive index of 1.48, and a surface energy of 28.3 mN/m.

### Preparation Example 4

### High Refractive Material

14 g of tetraethoxysilane, 1.3 g of gammamercaptopropyltrimethoxysilane, 1 g of water, 0.2 g of nitric acid, and 33.5 g of ethanol were mixed together, and subjected to sol-gel reaction at 25° C. for 48 hrs, followed by mixing with 30 g of ethanol and 20 g of butylcellosolve. The sol-gel reactant was diluted with 25 g of methanol dispersing liquid containing titanium dioxide with an average diameter of 20 nm (solid content 40%) and 175 g of methanol, and then uniformly mixed to prepare a high refractive coating solution.

At this time, it was found that the resulting solution had the solid content of 5% by weight, a refractive index of 1.77, and a surface energy of 31.2 mN/m.

### Preparation Example 5

### High Refractive Material

20 g of ethanol dispersing liquid containing indium-tin oxide with an average diameter of 20 nm (solid content 15%), 1.5 g of dipentaerythritol hexaacrylate (DPHA), 0.5 g of IRG 184, 40 g of ethanol and 38 g of methylethylketone as a solvent were uniformly mixed to prepare a high refractive coating solution.

At this time, it was found that the resulting solution had the solid content of 5% by weight, a refractive index of 1.64, and a surface energy of 29.8 mN/m.

### Preparation Example 6

### High Refractive Material

4.5 g of dipentaerythritol hexaacrylate (DPHA), 0.5 g of IRG 184, 50 g of ethanol and 45 g of methylethylketone as a solvent were uniformly mixed to prepare a high refractive coating solution.

At this time, it was found that the resulting solution had the solid content of 5% by weight, a refractive index of 1.52, and a surface energy of 35 mN/m.

### Example 1

50 g of the low refractive material prepared in [Preparation Example 1] and 50 g of the high refractive material prepared in [Preparation Example 4] were blended, and then applied to a hard coated triacetyl cellulose film using a Meyer bar #4. The film was dried, cured in an oven at 90° C. for 30 min.

### Example 2

50 g of the low refractive material prepared in [Preparation Example 2] and 50 g of the high refractive material prepared in [Preparation Example 5] were blended, and then applied to a hard coated triacetyl cellulose film using a Meyer bar #4. The film was dried, cured in an oven at 90° C. for 2 min, and then cured by UV radiation at a dose of 1 μm'.

### Example 3

The coating solution prepared in [Example 2] was applied to a hard coated triacetyl cellulose film using a Meyer bar #6. The film was dried, cured in an oven at 90° C. for 2 min, and then cured by UV radiation at a dose of 1 J/cm².

### Comparative Example 1

A film was manufactured in the same manners as in [Example 1], except using the low refractive material prepared in [Preparation Example 3].

### Comparative Example 2

A film was manufactured in the same manners as in [Example 2], except blending 50 g of the low refractive material prepared in [Preparation Example 2] with 50 g of the high refractive material prepared in [Preparation Example 6].

### Comparative Example 3

50 g of the high refractive material prepared in [Preparation Example 5] were blended, and then applied to a hard coated triacetyl cellulose film using a Meyer bar #4. The film was dried, cured in an oven at 90° C. for 2 min, and then cured by UV radiation at a dose of 1 J/cm². 50 g of the low refractive material prepared in [Preparation Example 2] were blended, and then applied to the high refractive and hard coated triacetyl cellulose film using a Meyer bar #4. The film was dried, cured in an oven at 90° C. for 2 min, and then cured by UV radiation at a dose of 1 J/cm².

Optical properties of the antireflection films manufactured in Examples and Comparative Examples were evaluated as follows:

1) Reflectance

The back side of the coating film was treated with black, and then reflectance was measured using a Solid Spec. 3700 spectrophotometer (Shimadzu) to determine the anti-reflection property depending on the minimum reflectance.

2) Transmittance and haze

The transmittance and haze of the coating film were evaluated using HR-100 (Murakami, Japan).

TABLE 1

| | Example | Example | Example | Comparative | Comparative | Comparative |
|---|---|---|---|---|---|---|
| | 1 | 2 | 3 | Example 1 | Example 2 | Example 3 |
| Minimum | 0.6 | 0.2 | 0.7 | 4.3 | 2.5 | 1.2 |
| reflectance (%) | | | | | | |
| Transmittance (%) | 96.5 | 96.6 | 96.3 | 94.3 | 95.6 | 96.1 |
| Haze (%) | 0.2 | 0.3 | 0.3 | 0.2 | 0.3 | 0.2 |

As a result, it was found that the films manufactured according to the present invention had excellent reflectance, transmittance and haze.

1. A coating composition for antireflection, comprising a) a low refractive material having a refractive index of 1.2 to 1.45, b) a high refractive material having a refractive index of 1.55 to 2.2 and comprising high refractive fine particles and an organic substituent, wherein the difference in the surface energy between two materials is 5 mN/m or more.

2. The coating composition for antireflection according to claim 1, wherein the low refractive material has a surface energy of 25 mN/m or less.

3. The coating composition for antireflection according to claim 1, wherein the low refractive material and the high refractive material are all thermosetting or UV curable materials.

4. The coating composition for antireflection according to claim 1, wherein the low refractive material is a low refractive thermosetting material and includes one or more selected from the group consisting of an alkoxysilane reactant causing a sol-gel reaction, a urethane reactive group compound, a urea reactive group compound, and an esterification reactant.

5. The coating composition for antireflection according to claim 4, wherein the low refractive thermosetting material includes fluorine.

6. The coating composition for antireflection according to claim 1, wherein the low refractive material is a low refractive UV curable material, and includes an acrylate resin, a photoinitiator, and a solvent.

7. The coating composition for antireflection according to claim 6, wherein the fluorinated acrylate is contained in an amount of 20 parts by weight or more, based on 100 parts by weight of the acrylate resin.

8. The coating composition for antireflection according to claim 1, wherein among the high refractive materials, the high refractive fine particle includes one or more selected from the group consisting of zirconium oxide (ZrO₂), titanium oxide (TiO₂), zinc sulfide (ZnS), antimony oxide (Sb₂O₃), zinc oxide (ZnO₂), indium tin Oxide (ITO), antimony tin oxide (ATO), titanium-antimony tin oxide (TiO₂, Sb doped SnO₂), cerium oxide (CeO), selenium oxide (SeO₂), aluminum oxide (Al₂O₃), yttrium oxide (Y₂O₃) and antimony-zinc oxide (AZO).

9. The coating composition for antireflection according to claim 1, wherein among the high refractive materials, the organic substituent is a thermosetting organic substituent selected from the group consisting of a silane reactant, a urethane reactant, a urea reactant, and an esterification reactant, or a UV curable organic substituent selected from two or more functional acrylate monomer and oligomer.

10. The coating composition for antireflection according to claim 1, wherein the organic substituent is contained in an amount of 0 parts by weight to 70 parts by weight, based on 100 parts by weight of the high refractive fine particles.

11. The coating composition for antireflection according to claim 1, wherein a weight ratio of the low refractive material and high refractive material is 3/7 to 8/2.

12. A method of manufacturing an antireflection film, comprising the steps of:
i) preparing the coating composition for antireflection according to claim 1, which includes a) a low refractive material having a refractive index of 1.2 to 1.45, b) a high refractive material having a refractive index of 1.55 to 2.2 and comprising high refractive fine particles and an organic substituent, in which the difference in the surface energy between two materials is 5 mN/m or more;
ii) applying the coating composition on a substrate to form a coating layer;
iii) drying the coating layer to allow the low and high refractive materials to have a concentration gradient in a thickness direction of the coating layer; and
iv) curing the dried coating layer.

13. The method of manufacturing an antireflection film according to claim 12, wherein the coating process of step ii) is performed to a dried coating thickness of 1 micrometer or less.

14. The method of manufacturing an antireflection film according to claim 12, wherein the drying process of step iii) is performed at a temperature of 5 to 150° C. for 0.1 to 60 min.

15. The method of manufacturing an antireflection film according to claim 12, wherein the curing process of step iv) is performed by heat treatment at a temperature of 20 to 150° C. for 1 to 100 min, or by UV radiation at a dose of 0.1 to 2 J/Cm² for 1 to 600 sec.

16. An antireflection film, comprising a single coating layer that includes a) a low refractive material having a refractive index of 1.2 to 1.45, b) a high refractive material having a refractive index of 1.55 to 2.2 and comprising high refractive fine particles and an organic substituent, wherein the difference in the surface energy between two materials is 5 mN/m or more and the low and high refractive materials have a concentration gradient in a thickness direction.

17. The antireflection film according to claim 16, wherein the antireflection film is manufactured by a method comprising the steps of:
i) preparing the coating composition for antireflection according to claim 1, which includes a) a low refractive material having a refractive index of 1.2 to 1.45, b) a high refractive material having a refractive index of 1.55 to 2.2 and comprising high refractive fine particles and an organic substituent, in which the difference in the surface energy between two materials is 5 mN/m or more;
ii) applying the coating composition on a substrate to form a coating layer;
iii) drying the coating layer to allow the low and high refractive materials to have a concentration gradient in a thickness direction of the coating layer; and
iv) curing the dried coating layer.

18. The antireflection film according to claim 16, wherein the single coating layer has a thickness of 1 micrometer or less.

19. The antireflection film according to claim 16, wherein the antireflection film includes a hard coating layer provided on one side of the single coating layer, and a substrate provided on one side of the hard coating layer.

20. The antireflection film according to claim 16, wherein the antireflection film has transmittance of 96% or more, minimum reflectance of 0.5% or less, and abrasion resistance of pencil hardness, 2H.

21. An antireflection film, comprising a single coating layer that includes a) a low refractive material having a refractive index of 1.2 to 1.45, and b) a high refractive material having a refractive index of 1.55 to 2.2, wherein the difference in the surface energy between two materials is 5 mN/m or more, the low and high refractive materials have a concentration gradient in a thickness direction, and the single coating layer has a thickness of 1 micrometer or less.

22. The antireflection film according to claim 21, wherein the antireflection film has transmittance of 96% or more, minimum reflectance of 0.5% or less, and abrasion resistance of pencil hardness, 2H.

23. The antireflection film according to claim 21, wherein the antireflection film includes a hard coating layer provided on one side of the single coating layer, and a substrate provided on one side of the hard coating layer.

24. A polarizing plate, comprising i) a polarizing film and ii) an antireflection film including a single coating layer that includes a) a low refractive material having a refractive index of 1.2 to 1.45, b) a high refractive material having a refractive index of 1.55 to 2.2 and comprising high refractive fine particles and an organic substituent, wherein the difference in the surface energy between two materials is 5 mN/m or more and the low and high refractive materials have a concentration gradient in a thickness direction.

25. A polarizing plate, comprising i) a polarizing film and ii) an antireflection film including a single coating layer that includes a) a low refractive material having a refractive index of 1.2 to 1.45 and b) a high refractive material having a refractive index of 1.55 to 2.2, wherein the difference in the surface energy between two materials is 5 mN/m or more, the low and high refractive materials have a concentration gradient in a thickness direction, and the single coating layer has a thickness of 1 micrometer or less.

26. A display device, comprising the antireflection film according to claim 16.

27. A display device, comprising the antireflection film according to claim 21.
